(19) United States
(12) Patent Application Publication
(10) Pub. No.: US 2015/0198352 A1
(43) Pub. Date: Jul. 16, 2015

(54) Grille door opener

(71) Applicants: Lynne Bruhnke, Massapequa Park, NY (US); Daniel Roeper, Garden City, NY (US)

(72) Inventors: Lynne Bruhnke, Massapequa Park, NY (US); Daniel Roeper, Garden City, NY (US)

(73) Assignee: Oemetrix, L.L.C.

(21) Appl. No.: 13/999,104

(22) Filed: Jan. 13, 2014

(51) Int. Cl. F24F 13/08; F24F 13/10; E05F 11/54

(52) U.S. Cl. CPC F24F 13/082; E05F 11/54; F24F 13/10

(57) ABSTRACT

A door opener for a linear bar grille.

### FIELD OF THE INVENTION

The present invention relates to a door opener for a linear bar grille.

### BACKGROUND OF THE INVENTION

U.S. Patent publication 2004/0231808 relates to a folding grille assembly to be used to close an opening in a narrowing wall. The grill assembly has a pocket and a folding grille. The pocket is adapted to be mounted on one side of the opening aligned with the wall and forming part of the wall. The folding grille has a plurality of narrow, vertical, panels, the panels hingedly joined together in serial fashion by vertical hinges. Every second panel only carries a vertical mounting rod at its top end extending up from the top, center of the panel, and every second mounting rod only carries a trolley by means of which the grille can be movably supported at the top opening of the grille. The pocket forms a receptacle for the grille when the grille is folded to open the opening.

US Patent publication 2008/0188175 relates to a recirculating fan, for installation in an upper region of a building space, and having, a housing, a fan, an air vent ring defining an intake path and a discharge path, an air grille for intake and discharge paths, the air grille being releasably attached to the housing and being moveable relative to the housing, and releasable fastening devices for releasably fastening the air grille to the housing.

U.S. Pat. No. 7,566,263 relates to a combination of a grille and a connector frame for a duct outlet in an HVAC system. At least one lock element extends from one of the connector frame and the grille and releasably engages the other of the connector frame and grille in a releasable connection to hold the grille to the connector frame. The lock element may be manipulated from the exterior of the grille to release the grille from the connector frame without the use of tools.

US patent publication 2007/0056229 relates to a fastening means of an air grille including a grille face, a filtering device, a stationary frame and door latches, in which the grid face is hinged to the stationary frame with one side, and the opposite side of the grid face is fastened on the stationary frame with the door latches. The door latches molded of plastic are located on the grid face in movable connection with a catching hook at the middle portion. A pushing portion is built upon the upside of the door latch, and a L-shaped catching shoe on the lower portion. Above the L-shaped catching shoe, the catching hook is built up for holding the grid face on, and an open slot constructed of the low leg of the L-shaped shoe and the bottom of the pushing portion is used to catch on the stationary frame. When opening the grid face, just need to push the door latches respectively to outward so as to slide off from the stationary frame, then the grid face is opened wholly; in this case, locking or opening of the grid face to install or remove the filter becomes easier.

### SUMMARY OF THE INVENTION

The present invention relates to a device for opening up a linear bar grille. The device comprises a recessed door lift handle. It is located between two bars of a linear bar grille access door. The access door is on an access door pivot. The recessed door lift handle comprises a pivot actuating projection. While in the closed position the recessed door lift handle only is above the bar where the pivot actuating projection is located.

The recessed door lift handle opens the access door by pushing on the pivot actuating projection and then pulling the recessed door lift handle up.

When the grille access door is lifted by the recessed door lift handle to its open position it creates an open access area.

It is an object of the present invention for the recessed door lift handle to be attached to a bar of the linear bar grille. It is an object of the present invention for a pivot pin to be attached to the bar of the linear bar grille so that the recessed door lift handle pivots from a closed to an open position and back. It is an object of the present invention for the bar to have a closed position stop pin to which the recessed door lift handle rests when it is in the closed position. It is an object of the present invention for the bar to have a pivot limit stop, to stop the door lift handle from moving any further when it is in the open position.

It is an object of the present invention for the recessed door lift handle to comprise a radiussed pivot actuating projection. It is an object of the present invention for the recessed door lift handle to comprise a precision machined counter balanced door lift end. It is an object of the present invention for the recessed door lift handle to comprise a pivot pin hole. It is an object of the present invention for the recessed door lift handle to comprise a radiussed finger grip. It is an object of the present invention for the recessed door lift handle to comprise a machined flat edge to match the profile of the linear bars on the grille.

It is an object of the present invention for the recessed door lift handle to not affect the free area of the bar grille more than 1%. It is an object of the present invention for the handle to match the aesthetics of the grille.

### BRIEF DESCRIPTION OF DRAWINGS

FIG. 1 is a top view of the present invention in the closed position

FIG. 2 is a top view of the present invention in the closed position

FIG. 3 is a top view of the present invention in the open position

FIG. 4 is an internal view of the handle of the present invention in the closed position.

FIG. 5 is an internal view of the handle of the present invention in the open position.

FIG. 6 is side view of the handle of the present invention.

### DETAILED DESCRIPTION OF THE INVENTION

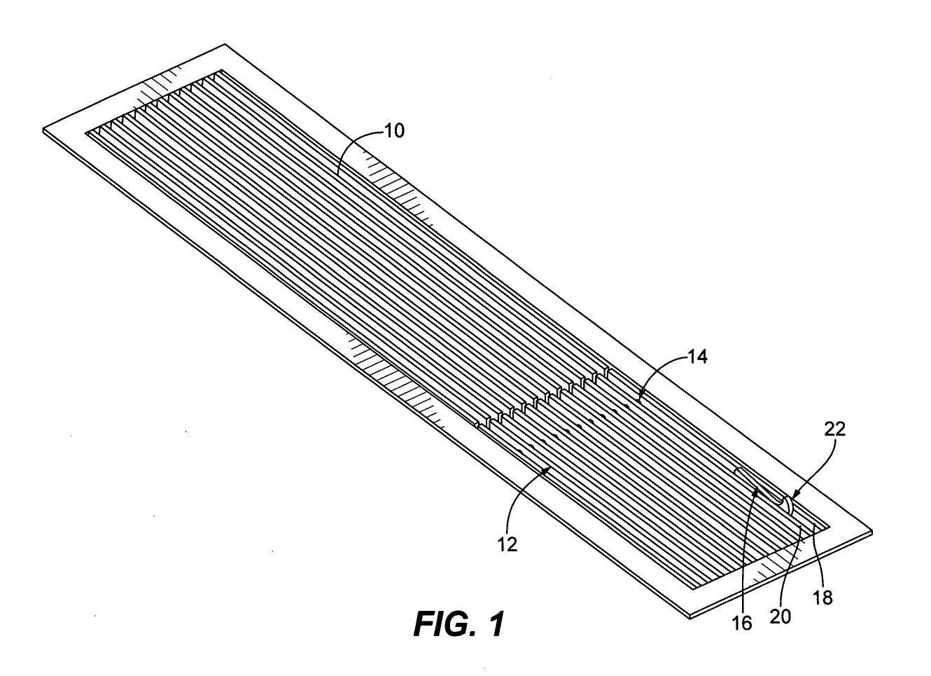

FIG. 1 shows the linear bar grille 10 having an access door 12. The access door 12 has an access door pivot 14. A recessed door lift handle 16 is located between two bars 18 and 20. The recessed door lift handle 16 has a pivot actuating projection 22. FIG. 1 shows the recessed door handle 16 in its closed internal position.

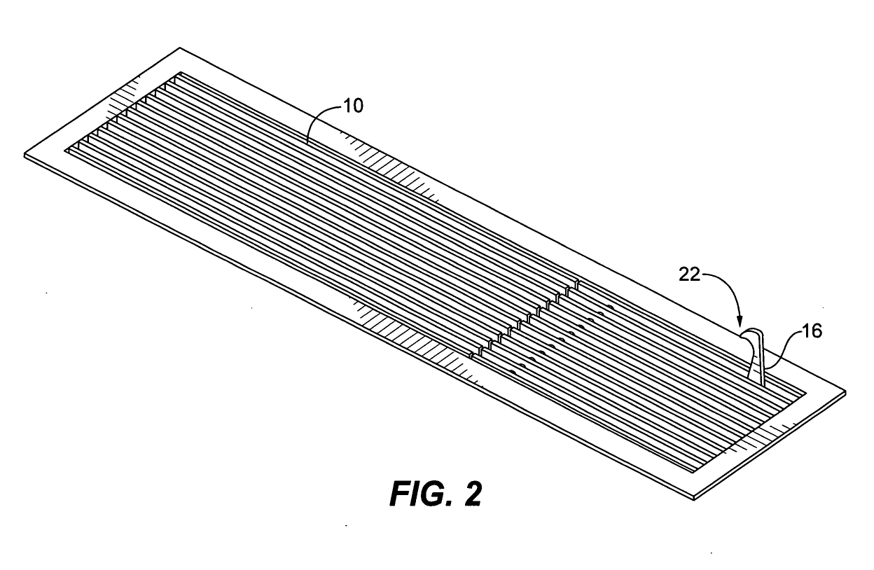

FIG. 2 shows the linear bar grille 10. The recessed door lift handle 16 is in its ready to lift position, having the pivot actuating projection 22 in its upward position.

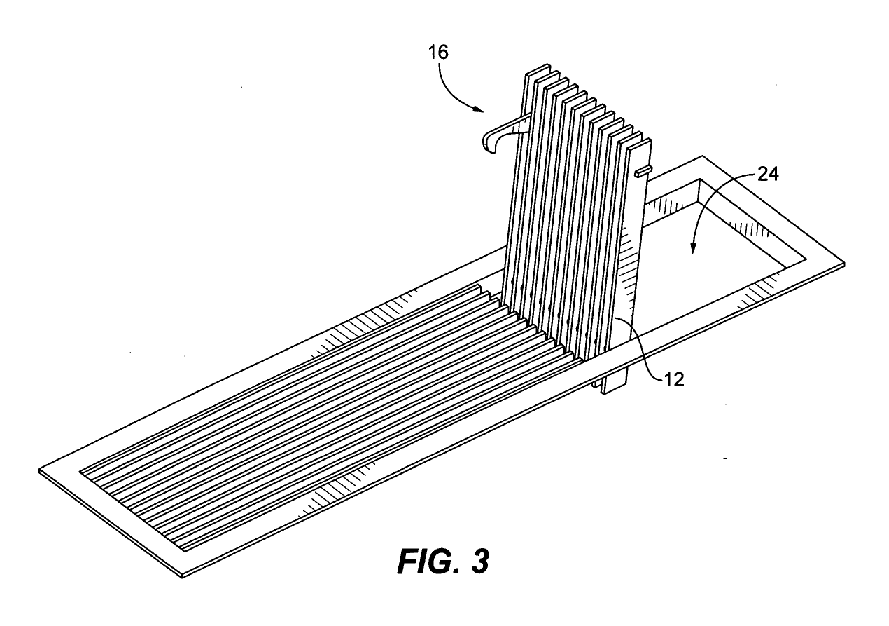

FIG. 3 shows the grille access door 12 in its open position. The recessed door lift handle 16 has been pulled by the user to provide the grille access door 12 in its open position. When the grille access door 12 is in its open position it creates an open access area 24.

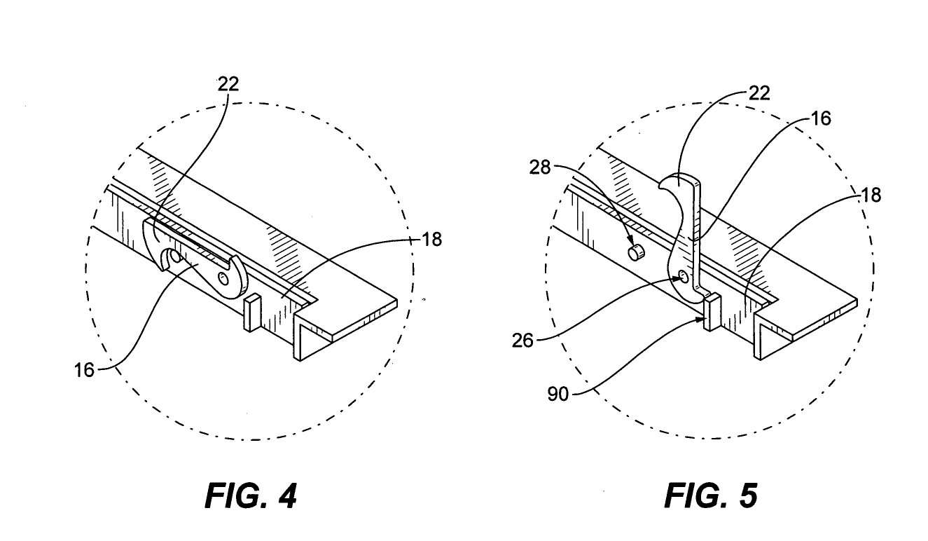

FIG. 4 shows the recessed door lift handle 16, having the pivot actuating projection 22 in its closed position. The door lift handle 16 is shown being attached to bar 18.

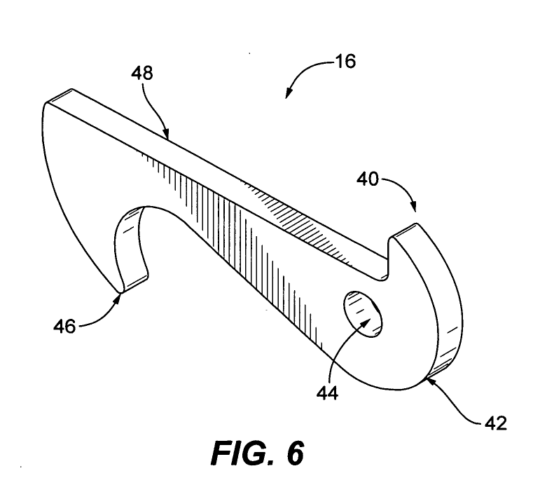

FIG. 5 shows the recessed door lift handle 16, having the pivot actuating projection 22 in the ready to lift position. The bar 18 has a pivot pin attached to it from which the recessed door lift handle 16 pivots from a closed to an open position and back. The bar 18 also has a closed position stop pin to which the recessed door lift handle 16 rests when it is in the closed position. Bar 18 also has a pivot limit stop 30 to stop the door lift handle 16 from moving any further when it is in the open position.

FIG. 6 shows the recessed door lift handle 16 having a radiussed pivot actuating projection 40, a precision machined counter balanced door lift end 42, a pivot pin hole 44, a radiussed finger grip 46 and a machined flat edge 48 to match the profile of the liner bars 18 on the grille 10.

1. A door opener for a linear bar grille comprising:
a recessed door lift handle located between two bars of a linear bar grille access door;
said access door attached to said linear bar grill by an access door pivot;
said recessed door lift handle comprising a pivot actuating projection.

2. The door opener of claim 1 wherein when said recessed door lift handle is in a closed position said recessed door lift handle only is above said bar where said pivot actuating projection is located.

3. The door opener of claim 1 wherein said access door is opened by pushing on said pivot actuating projection and then pulling said recessed door lift handle.

4. The door opener of claim 1 wherein when said access door is lifted by said recessed door lift handle to its open position it creates an open access area.

5. The door opener of claim 1 wherein said recessed door lift handle is attached to at least one of said two bars of said linear bar grille.

6. The door opener of claim 1 further comprising a pivot pin is attached to at least one of said two bars of said linear bar grille so that said recessed door lift handle pivots from a closed to an open position and back.

7. The door opener of claim 1 further comprising a closed position stop pin attached to at least one of said two bars to which said recessed door lift handle rests when it is in said closed position.

8. The door opener of claim 1 further comprising a pivot limit stop attached to at least one of said two bars to stop said door lift handle from moving any further when it is in the open position.

9. The door opener of claim 1 wherein said recessed door lift handle comprises a radiussed pivot actuating projection.

10. The door opener of claim 1 wherein said recessed door lift handle comprises a precision machined counter balanced door lift end.

11. The door opener of claim 1 wherein said recessed door lift handle comprises a pivot pin hole.

12. The door opener of claim 1 wherein said recessed door lift handle comprises a radiussed finger grip.

13. The door opener of claim 1 wherein said recessed door lift handle comprises a machined flat edge to match profile of said linear bars on said grille.

14. The door opener of claim 1 wherein said recessed door lift handle does not affect free area of said bar grille more than 1%.
